(19) United States
(12) Patent Application Publication
(10) Pub. No.: US 2004/0193643 A1
(43) Pub. Date: Sep. 30, 2004

(54) Method and system for tracking contracts

(76) Inventors: John C. O'Brien, Sterling Heights, MI (US); Kathleen A. Zawacki, Davisburg, MI (US)

Correspondence Address: BAKER BOTTS L.L.P., 2001 ROSS AVENUE, 6TH FLOOR, DALLAS, TX, 75201, US

(21) Appl. No.: 10/401,508

(22) Filed: Mar. 27, 2003

(51) Int. Cl. G06F 17/30

(52) U.S. Cl. 707/104.1

(57) ABSTRACT

One aspect of the invention is a method for generating a report that comprises storing data in a database, where the data includes a plurality of requirements associated with an entity and one or more deliverable items. In the database, at least some of the one or more deliverable items are linked with at least one of the requirements. A report is generated in response to the one or more deliverable items and the at least one of the requirements.

### TECHNICAL FIELD OF THE INVENTION

This invention relates generally to the field of contract management and more specifically to a method and system for tracking contracts.

### BACKGROUND OF THE INVENTION

Managing complex information technology (IT) projects generally requires tracking numerous items where a party is supplying IT services to a third party. Changes to the contracted-for performance during the project, may affect the costs of performance, the timelines of performance, and the manpower required for performance. Project managers may find difficulties in managing complex IT projects because client expectations of what the contract requires may differ from the views of the service provider. These problems are exacerbated by changes in the required performance. When a client changes the scope of the project, project managers frequently need to evaluate the resources no longer required, the new resources needed, and the cost of the changes to the client. In complicated IT contracts, these tasks can be difficult.

### SUMMARY OF THE INVENTION

One aspect of the invention is a method for generating a report that comprises storing data in a database, where the data includes a plurality of requirements associated with an entity and one or more deliverable items. In the database, at least some of the one or more deliverable items are linked with at least one of the requirements. A report is generated in response to the one or more deliverable items and the at least one of the requirements.

The invention has several important technical advantages. Various embodiments of the invention may have none, one, some, or all of these advantages without departing from the scope of the invention. One or more other technical advantages may be readily apparent to one skilled in the art from the figures, descriptions, and claims included herein. The invention allows efficient project management. Because the invention allows for reports to be produced, a project manager may efficiently track items associated with a particular contractual requirement or requirements for an entity and more effectively determine the progress and status of satisfying each contractual requirement as the contract is being performed. Thus, the project manager can, for example, determine and track the cost of the project, analyze the cost impact of changes, and track those contractual items for which performance has been given.

### BRIEF DESCRIPTION OF THE DRAWINGS

For a more complete understanding of the present invention and the advantages thereof, reference is now made to the following descriptions taken in conjunction with the accompanying drawings in which:

FIG. 1 is a block diagram of a general purpose computer that may be used in accordance with the present invention;

FIG. 2 illustrates an example of a database system that comprises an embodiment of the present invention;

FIGS. 3A-3C illustrate an example of reports that may be generated according to the present invention;

FIG. 4 illustrates a flowchart describing the generation of a project management database in accordance with one method of the present invention; and

FIG. 5 illustrates a flowchart describing one embodiment of a method for generating reports in accordance with the present invention.

### DETAILED DESCRIPTION OF THE DRAWINGS

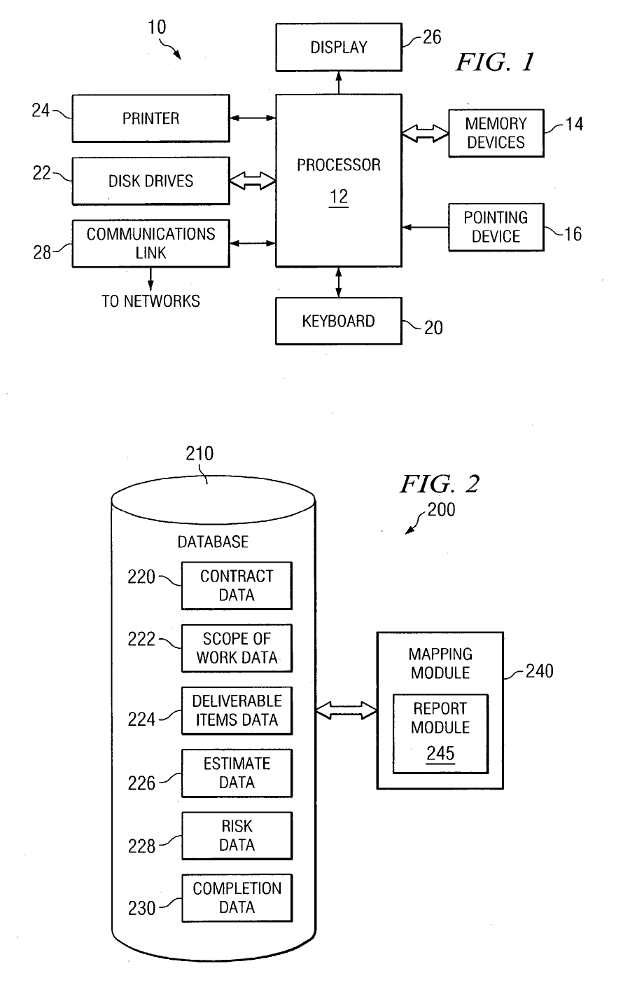

Embodiments of the present invention and their advantages are best understood by referring to FIGS. 1 through 4 of the drawings, like numerals being used for like and corresponding parts of the various drawings.

FIG. 1 illustrates a general purpose computer 10 that may be used for generating and using a project management database in accordance with the present invention. Specifically, general purpose computer 10 may comprise a portion of a database management system and may be used to execute applications comprising database management software. General purpose computer 10 may be adapted to execute any of the well known MS-DOS, PC-DOS, OS2, UNIX, MAC-OS, and Windows operating systems, or other suitable operating systems. General purpose computer 10 comprises a processor 12, memory devices 14, a pointing device 16, a keyboard 20, and input/output devices such as a printer 24, disk drives 22, a display 26, and a communications link 28. The present invention includes programs that may be stored in memory devices 14 or disk drives 22, and may be executed by processor 12. Communications link 28 is connected to a computer network, but could be connected to a telephone line, an antenna, a gateway, or any other suitable type of communication link. Disk drives 22 may include a variety of storage media such as, for example, floppy disk drives, hard disk drives, CD-ROM drives, or magnetic tape drives. Although this embodiment employs a plurality of disk drives 22, a single disk drive 22 could be used without departing from the scope of the invention. FIG. 1 only provides one example of a computer that may be used with the invention. The invention could be used with computers other than general purpose computers. For example, as used in this document, the term “computer” refers to any suitable device operable to accept input, process the input according to predefined rules, and produce output for example, a personal computer, workstation, network computer, wireless telephone, personal digital assistant (PDA), one or more microprocessors within these or other devices, or any other suitable processing device.

FIG. 2 illustrates a database system comprising an embodiment of the present invention. In general, database system 200 may comprise a database 210 and a mapping module 240. Database 210 stores data comprising information related to a contract for an entity, and mapping module 240 accesses the data to generate reports using a report module 245. Mapping module 240 may also be used to create relationships between contract items, scope of work items, and deliverable items as described below.

Database 210 may be local to or remote from the general purpose computer 10 or any other computer-being used to access database 210. Database 210 may be coupled to the computer using one or more local area networks (LANs), metropolitan area networks (MANs), wide area networks (WANs), a global computer network such as the Internet, or any other suitable wireline, wireless, or links. According to the illustrated embodiment, database system 210 may be created using a database software package available commercially such as Access, Foxpro, Dbase, Excel, or any other suitable database management application. According to the illustrated embodiment, database 210 is created using Access and reports are generated using the reporting capabilities of Access as a report module 245.

In this embodiment, database 210 includes contract data 220, scope of work data 222, deliverables data 224, estimate data 226, risk data 228, and completion data 230. Some or all of this data may be excluded or other data added without departing from the scope of the invention.

Contract data 220 may include information related to a contract. The contract information may comprise one or more contract clauses (literally or paraphrased), one or more contract requirements, master agreement schedule, or any contract item or items desirable for tracking. For example, contract data 220 may include a clause that requires a mean time between failure (MTBF) of a particular service. As another example, contract data 220 may include a service requirement such as, for example, a requirement to provide a call center or desktop services for the employees of a corporation. The invention is not limited to any particular type of contract requirements. Any number of contractual requirements may be included in contract data 220 without departing from the scope of the invention.

Scope of work data 222 may include information regarding the scope and objectives of a project associated with a contract. The scope of work information may include scope statements that define project parameters to accomplish each contract item. The scope of work data may include items such as portions or all of a scope document, a release, a report, a version, an upgrade, or any other identification defining the scope of work required by a project. Scope of work data 222 may include additional information such as project parameters, purposes, measurable success indicators, and project scope, without departing from the scope of the invention. Any number of scope statements may be included in scope of work data 222 without departing from the scope of the invention.

Scope of work data 222 may be associated with contract data 220. According to the illustrated embodiment, scope of work data work 222 may be linked to contract data 220. For example, one contract clause of contract data 220 may be linked to one or more scope statements of scope of work data 222. As another example, a scope statement of scope of work data 222 may be linked to more than one contract item of contract data 220. Accordingly, any suitable number of scope statements of scope of work data 222 may be linked to any number of contract items of contract data 220 without departing from the scope of the invention.

For example, a contract clause requiring a particular MTBF for a service may be linked to a particular release in the scope of work document further specifying a tool to measure MTBF for the service. The contract clause may only be associated with the particular release in a one-to-one relationship between the contract data item and the scope item. The contract clause, however, may be linked to other scope statements for a one-to-many relationship, for example, when the contract clause may require desktop services in addition to requiring the particular MTBF for the service, where the desktop services may be specified by one or more releases in the scope of work document. In a many-to-many relationship, the scope of work document may include multiple scope items each associated with more than one contract requirement. For example, a contract item may specify providing call center service while another contract item specifies providing video conferencing service. A scope statement may include a release including the MTBF tool that may be used to provide both services and therefore the release may be linked to both contract items. Another scope statement providing, for example, a disaster recovery plan as another release may similarly be linked to both contract items.

Deliverable items data 224 may include items that meet scope document and/or contract requirements. Deliverable items data 224 may include items determined by the IT service provider to satisfy the contractual requirements for a relevant contract. For example, deliverable items data 224 may comprise a work breakdown structure (WBS), which organizes the deliverable items in groups of project elements, the groups collectively defining the total scope of the project (or a subset of the project). As another example, deliverable items data 224 may include item details, each item detail identifying one item that may support at least one scope statement of the scope document. According to the illustrated example, deliverable items may include a software license, hardware requirement, human resources needed, tools to measure a specific metric, hardware service, or any other suitable item detail supporting at least one scope statement of the scope of work data 222.

Deliverable items of the deliverable items data 224 may be associated with a contractual requirement of contract data 220. Deliverable items data 224 may be linked to scope of work data 222 and/or contract data 220 to provide for tracking contract requirements and their associated deliverable items throughout the project. For example, one deliverable item may be associated with one or more scope of work statements. As another example, a plurality of scope statements may be associated with a plurality of deliverable items. Any number of deliverable items may be linked to any number of scope statements without deviating from the scope of the invention.

According to one embodiment, deliverable items may be linked to scope items and contract items in a one-to-one relationship, one-to-many relationship, and many-to-many relationship. As an example of a one-to-one relationship, a scope statement for providing a software upgrade may be linked to one deliverable item, such as installing software upgrade at 100 desktops. As an example of a one-to-many relationship between the scope item and deliverable items, the scope statement for providing a software upgrade may be linked to multiple deliverable items, such as installing software upgrade at 100 desktops and providing user training on new features included in software upgrade. The deliverable items, however, may be linked to other scope statements for a one-to-many relationship. For example, two scope statements may specify providing a call center and providing instant messaging, and multiple deliverable items, such as providing printer service and providing training, may be associated with both scope statements. The scope statement for providing a call center may be linked to both deliverable items, providing printer service and providing training, and the scope statement for providing instant messaging may also be linked to the same deliverable items.

In this embodiment, one or more scope items are linked to one or more contractual requirements and one or more deliverable items are linked to one or more scope items. In other embodiments, the contractual requirements could be omitted and deliverable items linked to scope items. Similarly, deliverable items could be linked to contract requirements and scope items could be omitted. Where both scope items and contractual requirements are included, deliverables could be linked to either one or both of the scope items and contractual requirements. Scope items and contractual requirements might or might not be linked to one another.

Estimate data 226 may include an estimate of resources used to deliver each of the deliverable items. Estimate data 226 may include multiple estimates for each deliverable item. For example, estimate data 226 may include an estimate of man hours, costs of hardware, facility costs of hardware, or any other suitable identifier of costs associated with a deliverable item. Any number of estimates for a deliverable item may be used as estimate data 226 without departing from the scope of this invention. Estimate data may include estimates of cost, price, and/or profit margin.

Risk data 228 may include an assessment of risks associated with a deliverable item. The risk may be assessed as a percentage of how the deliverable item may affect the costs estimated for that deliverable item. For example, high risk items may be perceived to expend a high percent of a risk while low risk items may be perceived to expend a low percentage. This risk assessment may, for example, be a percentage estimate of the potential increased costs that could result for a deliverable item due to uncertainty related to its actual cost. Percentage may be assessed as a perception of the risk of each deliverable item without departing from the scope of this invention.

Risk data 228 may also include a risk dollar volume assessment. According to the illustrated embodiment, a risk dollar volume assessment may comprise the hours estimated in estimate data 226 multiplied by the hourly costs of implementing the risk factor. For example, a deliverable item having a low risk may have a low risk dollar volume as compared to the same item having a higher risk. Although the risk dollar volume and risk estimates of risk data 228 are associated with one or more deliverable items, risk data 228 may be linked to estimate data 226, deliverable items data 224, scope of work data 222, and contract data 220 without departing from the scope of the invention.

As an example, suppose a deliverable item is assessed a 70% risk of not meeting the contract specification by considering factors such as, for example, experience in delivering the item, success of delivery experienced in the past, and unexpected costs that may arise due to the item being an emerging technology. (Other factors may be considered without departing from the scope of the invention.) This 70% risk percentage may be used for example, to calculate a risk volume assessment for the item to provide an estimate of the potential increased cost of delivering the item. For this example, the risk volume could be calculated by first establishing the monthly cost of the item, estimating the usage dictated by the contractual requirements, and multiplying the cost by the usage. The risk volume assessment may include a recovery margin determined by inflating the risk volume by the risk percentage. For example, a deliverable item having a 70% risk and having a projected cost of $18,000 may be applied a margin yielding a risk volume assessment, for example, of $30,600.00. A project manager, (or other person) may use this data to negotiate changes to the contract and to assess the potential costs associated with satisfying the contractual requirements. Such data may also be used to aid in pricing a contract during negotiation.

Completion data 230 includes information of when each deliverable item was completed in whole or in part. Completion data 230 may include, for example, dates of completion, a check-off mark indicating completion of delivery, signoff information, or any other information suitable for tracking completion of delivery or implementation.

Mapping module 240 may be used to access the database 210 and to detect links between data structures in database 210. Mapping module 240 includes a report module 245. In general, mapping module 240 may be co-located with database 210, or may be located remotely from computer 10. Mapping module 240 may be located in a separate computer without departing from the scope of the invention. According to the illustrated embodiment, mapping module 240 is an application layer of a database management software.

Report module 245 generates reports. According to one embodiment, report module 245 may comprise an application layer operable to arrange selected data of database 210 according to a report format. One report may comprise contract data 220, scope of work data 222, and deliverable items 224 arranged to illustrate their associations or links. As noted above, some embodiments may omit some of these categories of data or linkages and a corresponding appropriate report could be generated. For example, a report format may be used to generate a report displaying deliverable items linked to contract requirements. Using the generated report, a project manager may for example, perform a gap analysis to determine if any contract requirement has not been associated with one or more scope items or deliverable items. Gap analysis may also determine if certain scope or deliverable items have not been linked with a corresponding contractual requirement. The results of gap analysis may assist a project manager in assigning deliverable items to the contract requirement so that subsequent reports reflect a link between the contract requirement and the assigned deliverable item. A project manager may also use this report to attempt to prevent certain requirements from going unfulfilled or being partially fulfilled due to an oversight.

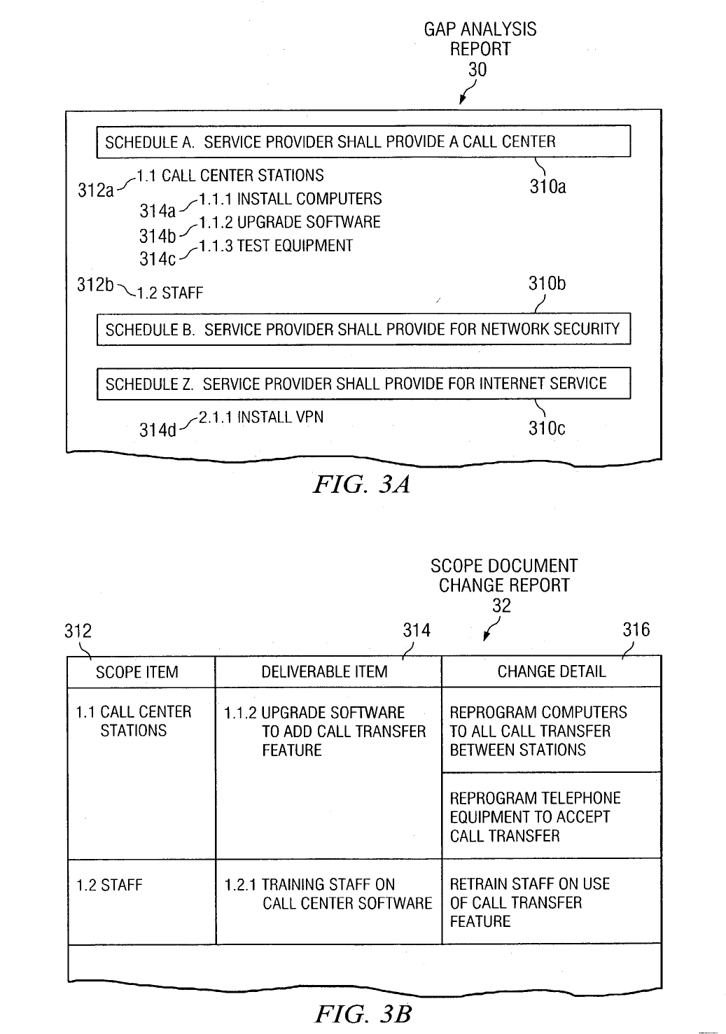

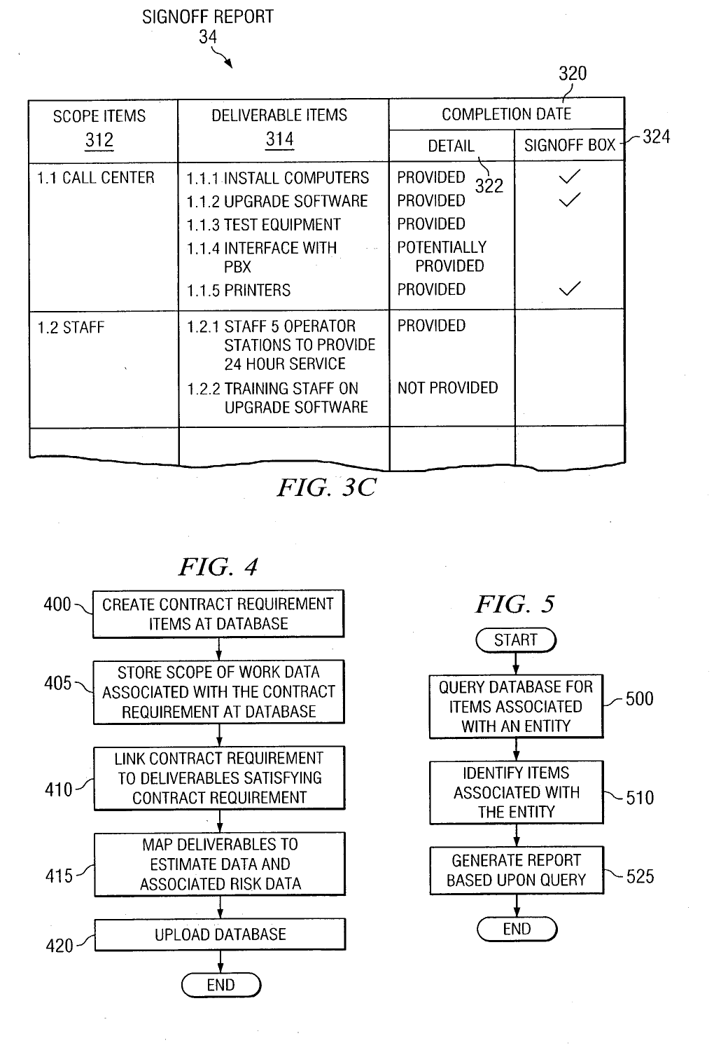

Embodiments of reports that may be generated by report module 245 are illustrated with reference to FIGS. 3A-3C. An example of a gap analysis report 30 is shown with reference to FIG. 3A. The gap analysis report 30 may include contract items 310, scope items 312, and deliverable items 314 arranged in any suitable order that may be used to identify stand-alone deliverable items, stand-alone contract items, and stand-alone scope items for the purpose of early identification of missing scope, deliverable items or services. The report shows contract item 310a as specifying Schedule A of the contract, where the service provider shall provide a call center. Scope items 312a and 312b, specifying items described, for example, as call center stations and staff, respectively, are illustrated as being associated with contract item 310a. Deliverable items 314a, 314b, and 314c, specifying, for example, installing computers, upgrading software, and testing equipment, respectively, are illustrated as being associated with call center scope item 312a. A project manager (or any other person), for example, may use gap analysis report 30 to determine that scope item 312b, specifying staff for the call center, is a stand-alone scope item since no deliverable items are associated with it. Gap analysis report 30 may aid in identifying stand-alone contract item 316b, as a stand-alone contract item. For example, contract item 316b specifies providing network security with no scope items or deliverable items associated with it, when according to a service provider, providing network security would normally be associated with at least one deliverable item. Gap analysis report 30 may also illustrate stand-alone deliverable items, for example, when deliverable items are not linked to any scope item. According to the illustrated embodiment, deliverable item 314d specifies item 2.1.1 Install VPN, which is not associated with any scope item under the contract item 310c comprising Schedule Z, where service provider shall provide for Internet service. Deliverable item 314d may be identified as a stand-alone deliverable item. Any additional information or data may be included in gap analysis report 30 or some of the included data omitted to provide any suitable information for analyzing link gaps.

Another report that may be generated is a scope document change report. The scope document change report may comprise contract data 220, scope of work data 222, and deliverable items data 224. The scope document change report may be used to show modifications to the scope statement, contract requirements, or modifications of deliverable items and how they affect other requirements, items, and/or price. The scope document change format may also include estimate data 226 and risk data 228 to show an assessment of the effect of modifications to the scope document. For example, the scope document change format may be used to show a cost estimate and risk assessment of changing a deliverable item.

FIG. 3B illustrates an example of an embodiment for reporting scope document changes. A scope document change report 32 may include scope items 312, deliverable items 314, and change details 316 and illustrates the association between scope items, deliverable items and the changes in the scope. For example, a scope item specifying call center stations may be modified to add a deliverable item 1.1.2 for upgrading software. Scope document change report 32 may illustrate details associated with this change, such as reprogramming computers to add call transfer between stations and reprogramming telephone equipment to accept transferred calls. As illustrated with reference to FIG. 3B, change detail 316 may include one or more change items associated with deliverable items 314, hence, identifying additional expense to the contract, services, or deliverable items.

The scope changes may further be tracked by issuing a communication, for example, by using issue tracking software. According to one embodiment, the scope document change report 32 lists the changes to the scope and shows a tracking number that may be assigned to each change. According to another embodiment, tracking of each change may be accomplished using IssueTrak software by IssueTrak, Inc. Tracking issues may be accomplished in conjunction with generating a scope document change report 32. For example, scope document change report 32 may include additional data, such as the contract items associated with scope items 312, issue numbers corresponding to each change of scope, or any other suitable data that may be useful in tracking scope changes for a given service contract. The report may be used alone or in combination with other reports and programs without departing from the scope of the invention. Other data may be included or some of this data omitted without departing from the scope of the invention.

Yet another report that may be generated is a client report. The client report may be used to show each deliverable item that has been completed during a particular timeframe. For that purpose, in addition to some or all of contract data 220, scope of work data 222, and deliverable items data 224, the client report may include completion data 230 to show completion information for each deliverable item.

FIG. 3C illustrates an example of an embodiment for signoff report 34. According to the illustrated embodiment, signoff report 34 includes scope items 312, deliverable items 314, completion data 320 and illustrates the associations between these items. Completion data 320 may include one or more fields of data, such as, for example, a detail of completion box 322 and a signoff box 324. Detail of completion 322 may include information on whether the deliverable items 314 are provided as deliverables associated with each scope item 312, whether the deliverable item would be potentially provided at a later date as part of the scope item 312, whether the deliverable item will not be provided with the current scope item but has been identified as a possible item to negotiate with the client, or any other suitable indicator for planning each deliverable item 314 to satisfy the scope item 312. Signoff box 324 includes data to represent that the deliverable item corresponding to the signoff box has been delivered, has been accepted, or any other suitable indicator that the deliverable item has been acknowledged by the client. As an example, scope item 312 requiring a call center is associated with deliverable items, such as install computers, upgrade software, test equipment, interface with PBX, and providing printers. Detail 322 may show that installing computers is a deliverable that will, or has been, provided, while the item of interfacing with a PBX may be only potentially provided. Some, none, or all of the deliverable items may be provided, not provided, or potentially provided for in the contract. Including a checkbox in signoff box 324 may indicate that the computers have been installed and that the printers have been provided.

According to the illustrated example, signoff report 34 may be used in support of a Contract, Scope, Deliverable Agreement where the client may agree that the project scope and deliverable items as shown in the attached report define the expected product of the project. As another example, contract data 220 may be included to illustrate that the contract has been performed in full, partially, or has been agreed to include the deliverable items associated with the contract. Any other data suitable for providing signoff information may be included in signoff report 34 or some of the included data omitted without departing from the scope of the invention.

Yet another report that may be generated is the tracking cost report. The tracking cost report may display linkages between contract requirements, scope items, deliverable items, risk data, and estimate data as appropriate to the particular embodiment. By displaying the estimated costs associated with each deliverable item, tracking costs is more easily performed. For example, if a deliverable item is modified, the assessed risk may be adjusted to reflect the new risks and the estimate data may be updated to reflect additional costs of changing the deliverable item. The cost of the project may therefore be tracked from the assessed estimates costs at the inception of the project. A project manager may use the tracking cost report to estimate the costs of changes in deliverable items during the project or to track costs as the project is performed. It is understood that any suitable report may be generated by database system 200 to display any linkages corresponding to the data of database 210, without departing from the scope of the invention.

Any other suitable report may be generated using any suitable report format without departing from the scope of the invention. For example, a report format may be generated to report links between estimate data 226 and contract data 220 to determine if a contract requirement is performed within estimated costs.

FIG. 4 illustrates a flowchart describing an example method for generating and populating database 210. The method begins at step 400, where contract requirement items are created in database 210. Contract requirement items may be stored as contract data 220 as described with reference to FIG. 2. This step may be omitted in embodiments not using contract requirements.

The method proceeds to step 405, where scope of work data 222 associated with the contract requirement items are stored in database 210. The scope of work data includes scope statements associated with contract requirement items. This step may be omitted in embodiments not using scope of work items. In addition to storing scope of work data, deliverable items associated with the scope statements may be stored in the database.

At step 410, the contract requirements items may be linked to the deliverable items that satisfy the contract requirements. According to one embodiment, deliverable items may be linked to the contract requirements and scope statements of the scope of work data using one-to-one relationships, one-to-many relationships, or many-to-many relationships. Scope statements may be similarly linked to contract requirements in some embodiments. For example, deliverable items may be linked to the contract requirements so that one deliverable item is linked to one statement of work item and one contract requirement. As another example, one deliverable item may be linked to several scope items and several contract requirements. As yet another example, one contract requirement may be associated with one or more scope statements and one or more deliverable items, where those deliverable items may be associated with that contract requirement and several others. Deliverable items may be linked to any suitable number of scope statements and any suitable number of contract requirement in any suitable association or relationship without deviating from the scope of this invention.

The method proceeds to step 415, where mapping module 240 associates deliverables with estimate data 226 and associated risk data 228. The deliverable items may be associated with estimate data 226 and associated risk data 228 to show variations in estimated costs and risks associated with accomplishing or delivering each deliverable item. This step may be eliminated without departing from the scope of the invention.

The method proceeds to step 420, where a database is uploaded to a server. Uploading database 210 makes database 210 accessible to a project manager, or any other person, for accessing the data, querying the data, using report module 245 to generate reports based on the data, or modifying the data to reflect changes in the contract requirements and associated data. Any other suitable data management for providing access to database 210 may be performed without departing from the scope of the invention. In some embodiments, database 210 may be accessible at all times such as when database 210 is stored in a personal computer making uploading to a server unnecessary. Alternatively, to control access to database 210, other techniques of access may be used such as password protection. After uploading database 210, the method terminates.

Steps may be added, omitted, modified, or performed in any suitable order without departing from the scope of the invention. For example, the step of linking contract requirements to deliverable items satisfying the contract requirements at step 410 may be performed substantially simultaneously with mapping deliverable items to estimate data 226 and associated risk data 228 at step 415.

FIG. 5 illustrates a flowchart describing an example method for generating reports according to the present invention. The method begins at step 500, where a database 210 is queried for items associated with an entity. The database may be queried using commands input by the user or according to a report format. A project manager wishing to generate reports may query database 210 for items associated with the contract requirements for an entity. For example, database 210 may be queried for deliverable items, scope items, or contract requirement items associated with a particular entity. The query may also include instructions to retrieve all the items that may be associated with a contract requirement or scope item. Any data of database 210 may be queried without departing from the scope of the invention and the query may comprise any suitable instruction without departing from the scope of the invention.

The method proceeds to step 510, where database system 200 identifies the items associated with the entity in response to the query. A report is generated at step 525 where the report displays the data based upon the query. As discussed above, the report generated may utilize various formats and many different kinds of reports as possible. Any of the reports discussed above may be generated.

To aid the Patent Office, and any readers of any patent issued on this application in interpreting the claims appended hereto, applicants wish to note that they do not intend any of the appended claims to invoke ¶ 6 of 35 U.S.C. § 112 as it exists on the date of filing hereof unless “means for” or “step for” are used in a particular claim.

Although an embodiment of the invention and its advantages are described in detail, a person skilled in the art could make various alterations, additions, and omissions without departing from the spirit and scope of the present invention as defined by the appended claims.

What is claimed is:

1. A method of generating a report, comprising:
storing in a database, data representing:
a plurality of requirements associated with an entity, and
one or more deliverable items;
linking in the database at least one of the one or more deliverable items with at least one of the requirements; and
generating a report in response to the one or more deliverable items and the at least one of the requirements.

2. The method of claim 1, further comprising
storing estimate data in the database for at least some of the one or more deliverable items, the estimate data comprising an estimate of resources to deliver each of the one or more deliverable items; and
wherein the report further comprises at least some of the estimate data.

3. The method of claim 1, further comprising:
storing risk data in the database for at least some of the one or more deliverable items, the risk data comprising an assessment of risk in delivering each of at least some of the one or more deliverable items; and
wherein the report further comprises one data value based upon at least the risk data.

4. The method of claim 1, further comprising:
storing completion data in the database and associating it with a deliverable item, when a deliverable item has at least been partially completed; and
wherein the report further comprises one or more deliverable items that have been at least partially completed during a given time frame.

5. The method of claim 1, wherein generating the report further comprises illustrating an association between ones of the deliverable items and one or more of the requirements.

6. The method of claim 1, wherein the requirements comprise contract requirements.

7. The method of claim 1, wherein the requirements comprise scope requirements.

8. The method of claim 1, further comprising:
changing some of the data,
generating a report in response to the changed data.

9. The method of claim 1, wherein the requirements comprise scope requirements, contract requirements or both scope requirements and contract requirements.

10. The method of claim 9, wherein the linking further comprises linking the at least one of the one or more deliverable items with at least one of the scope requirements.

11. The method of claim 9, wherein the at least one of the one or more deliverable items is linked to at least one of the contract requirements.

12. The method of claim 9, wherein the at least one of the one or more deliverable items is linked to at least one of the scope requirements and at least one of the contract requirements.

13. The method of claim 9, further comprising linking at least one of the scope requirements with at least on of the contract requirements.

14. The method of claim 9, wherein the report further illustrates one or more deliverable items associated with one or more scope requirements and one or more scope requirements associated with one or more contract requirements.

15. The method of claim 9, further comprising:
storing estimate data in the database for ones of the one or more deliverable items, the estimate data comprising an estimate of resources to deliver each of the ones of the one or more deliverable items;
storing risk data in the database for ones of the one or more deliverable items, the risk data comprising an assessment of risk in delivering each of ones of the one or more deliverable items; and
wherein the report further comprises illustrating a risk assessment, wherein the risk assessment is based upon the estimate data and risk data for the ones of the one or more deliverable items.

16. The method of claim 9, further comprising:
storing risk data in the database for at ones of the one or more deliverable items, the risk data comprising an assessment of risk in delivering each of the ones of the one or more deliverable items; and
wherein the report further comprises illustrating a risk assessment, wherein the risk assessment is based upon the risk data for ones of the one or more deliverable items.

17. The method of claim 9, further comprising:
storing completion data in the for ones of the one or more deliverable items, when the ones of the one or more deliverable items have at least been partially completed; and
wherein the report further comprises a completion report for the ones of the one or more deliverable items, the report generated in response to the completion data.

18. A database comprising:
a computer readable storage medium;
data stored in the computer readable storage medium representing:
a plurality of requirements associated with an entity; and
a plurality of deliverable items; and
links associating at least some of the one or more of the deliverable items with at least one of the requirements.

19. The database of claim 18, wherein the requirements comprise contract requirements.

20. The database of claim 18, wherein the requirements comprise scope requirements.

21. The database of claim 18, wherein the requirements comprise scope requirements, contract requirements, or both contract requirements and scope requirements.

22. The database of claim 18, the data further representing:
risk data for ones of the one or more deliverable items, the risk data comprising an assessment of risk in delivering the ones of the one or more deliverable items; and
wherein the links associate at least some of the risk data with the ones of the one or more deliverable items.

23. The database of claim 18, the data further representing:
completion data for ones of the one or more deliverable items when the ones of the one or more deliverable items have at least been partially completed.

24. A set of logic for project management, comprising:
a medium;
logic embedded on the medium operable to:
store in a database, data representing:
a plurality of requirements associated with an entity, and
one or more deliverable items;
link in the database at least some of the one or more deliverable items with at least one of the requirements; and
generate a report in response to the one or more deliverable items and the at least one of the requirements.

25. The logic of claim 24, wherein the requirements comprise contract requirements.

26. The logic of claim 24, wherein the requirements comprise scope requirements.

27. The logic of claim 24, wherein the requirements comprise scope requirements, contract requirements, or both contract requirements and scope requirements;

28. The logic of claim 24, the data further representing:
estimate data for at least some of the one or more deliverable items, the estimate data comprising an estimate of resources to deliver each of the one or more deliverable items; and
wherein the report further comprises at least some of the estimate data.

29. The logic of claim 24, the data further representing:
risk data for ones of the one or more deliverable items, the risk data comprising an assessment of risk in delivering the ones of the one or more deliverable items; and
wherein the report further comprises at least some of the risk data.

30. The logic of claim 24, the data further representing:
completion data associated with ones of the one or more deliverable item when the ones of the one or more deliverable item have at least been partially completed; and
wherein the report further comprises at lease some of the one or more deliverable items that have been at least partially completed during a given time frame.

31. The logic of claim 24, wherein generating the report further comprises illustrating an association between ones of the deliverable items and one or more of the requirements.

32. The logic of claim 27, wherein the report further comprises illustrating an association between ones of the one or more deliverable items and at least one of the scope requirements and at least one of the contract requirements.

33. The logic of claim 24, wherein a first set of the plurality of requirements is linked to a first plurality of the deliverable items and wherein the first plurality of the deliverable items is linked to the first set of the plurality of requirements.
